(19) United States
(12) Patent Application Publication
(10) Pub. No.: US 2019/0230505 A1
(43) Pub. Date: Jul. 25, 2019

(54) PAIRING WITH IMAGE CAPTURE DEVICES

(71) Applicant: GoPro, Inc., San Mateo, CA (US)

(72) Inventors: Daryl Stimm, Encinitas, CA (US); David Newman, San Diego, CA (US); Jeffrey Shane Youel, Rancho Santa Fe, CA (US)

(21) Appl. No.: 15/801,575

(22) Filed: Nov. 2, 2017

(51) Int. Cl. H04W 12/06; G06K 7/14; H04W 8/20; H04L 29/06

(52) U.S. Cl. CPC H04W 12/06; H04L 63/0853; H04W 8/205; G06K 7/1417

(57) ABSTRACT

Setup information including credential information for a computing device to connect to a wireless communication connection may be obtained. A machine-readable optical code may be generated based on the setup information. The machine-readable optical code may convey instructions configured to cause an image capture device to, in response to the image capture device capturing an image including the machine-readable optical code, establish the wireless communication connection and authenticate the computing device to the wireless communication connection by virtue of the computing device providing at least some of the credential information included in the setup information. The machine-readable optical code may be presented on a display. The computing device may connect to the wireless communication connection by wirelessly providing at least some of the credential information to the image capture device. The computing device may communicate with the image capture device via the wireless communication connection.

### FIELD

This disclosure relates to pairing with image capture devices using a machine-readable optical code conveying setup instructions for the image capture devices.

### BACKGROUND

Manually pairing a computing device with an image capture device may be difficult and time consuming. Manually pairing a computing device with an image capture device may require identification of wireless connection used by the image capture device.

### SUMMARY

This disclosure relates to pairing with an image capture device. Setup information including credential information for a computing device to connect to a wireless communication connection and/or other information may be obtained. A machine-readable optical code may be generated based on the setup information and/or other information. The machine-readable optical code may convey instructions configured to cause the image capture device to, in response to the image capture device capturing an image including the machine-readable optical code, establish the wireless communication connection and authenticate the computing device to the wireless communication connection by virtue of the computing device providing at least some of the credential information included in the setup information. The machine-readable optical code may be presented on a display. The computing device may connect to the wireless communication connection by wirelessly providing at least some of the credential information and/or other information to the image capture device. The computing device may communicate with the image capture device via the wireless communication connection.

A computing device that pairs with an image capture device may include one or more a display, a processor, and/or other components. In some implementations, the computing device may include a mobile device. The display may be configured to present one or more machine-readable optical codes and/or other information.

The processor(s) may be configured by machine-readable instructions. Executing the machine-readable instructions may cause the processor(s) to facilitate pairing with the image capture device. The machine-readable instructions may include one or more computer program components. The computer program components may include one or more of a setup information component, an optical code component, a presentation component, a connection component, a communication component, and/or other computer program components.

The setup information component may be configured to obtain setup information and/or other information. The setup information may include credential information for the computing device to connect to a wireless communication connection. The wireless communication connection may include one or more networks. In some implementations, the credential information may include one or more of a service set identifier, a user identifier, a user password, and/or other information. In some implementations, the setup information may include parameter information that defines one or more parameters for setting up the image capture device.

In some implementations, obtaining the setup information may include effectuating presentation of options for the setup information on the display, and receiving a user's selection of at least one of the options as the setup information. In some implementations, the options may include one or more pre-stored options. In some implementations, the options may include one or more dynamically generated options.

The optical code component may be configured to generate the machine-readable optical code based on the setup information and/or other information. The machine-readable optical code may conveying first instructions configured to cause the image capture device to, in response to the image capture device capturing an image including the machine-readable optical code, establish the wireless communication connection and authenticate the computing device to the wireless communication connection by virtue of the computing device providing at least some of the credential information included in the setup information and/or other information.

In some implementations, the machine-readable optical code may further convey second instructions configured to cause the image capture device to, in response to the image capture device capturing the image including the machine-readable optical code, change one or more setting parameters of the image capture device based on the parameter(s) defined by the parameter information.

The presentation component may be configured to effectuate presentation of the machine-readable optical code and/or other information on the display. In some implementations, the presentation component may effectuate presentation of the machine-readable optical code based on user input. In some implementations, the presentation component may effectuate presentation of the machine-readable optical code based on proximity of the image capture device to the computing device.

In some implementations, the image capture device may be configured to continuously or periodically search for the machine-readable optical code within images captured by the image capture device. In some implementations, the image capture device may be configured to search for the machine-readable optical code within images captured by the image capture device based on user input and/or other information.

The connection component may be configured to connect to the wireless communication connection by wirelessly providing at least some of the credential information and/or other information to the image capture device. The connection component may, prior to connecting to the wireless communication connection, detect the wireless communication connection.

The communication component may be configured to communicate with the image capture device via the wireless communication connection. Communication with the image capture device may include information provided to/transmitted to the image capture device and/or information provided by/received from the image capture device.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example computing device that pairs with an image capture device.

FIG. 2 illustrates an example method for pairing with an image capture device.

FIG. 3 illustrates an example display of machine-readable optical code for pairing with an image capture device.

FIG. 4 illustrates an example display of machine-readable optical code for pairing with multiple image capture devices.

FIG. 5 illustrates an example process for pairing with an image capture device.

### DETAILED DESCRIPTION

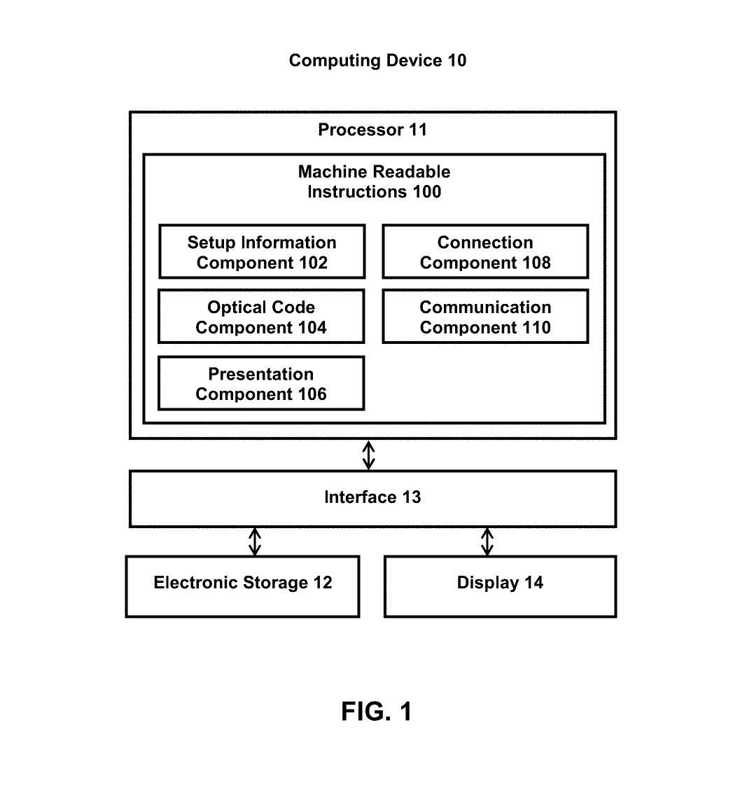

FIG. 1 illustrates a computing device 10 that pairs with an image capture device. The computing device 10 may include one or more of a processor 11, an electronic storage 12, an interface 13 (e.g., bus, wireless interface), a display 14, and/or other components. Setup information including credential information for the computing device 10 to connect to a wireless communication connection and/or other information may be obtained by the processor 11. A machine-readable optical code may be generated based on the setup information and/or other information. The machine-readable optical code may convey instructions configured to cause an image capture device to, in response to the image capture device capturing an image including the machine-readable optical code, establish the wireless communication connection and authenticate the computing device 10 to the wireless communication connection by virtue of the computing device 10 providing at least some of the credential information included in the setup information. The machine-readable optical code may be presented on the display 14. The computing device 10 may connect to the wireless communication connection by wirelessly providing at least some of the credential information and/or other information to the image capture device. The computing device 10 may communicate with the image capture device via the wireless communication connection.

In some implementations, the computing device 10 may include a mobile device. A mobile device may refer to a portable computing device. For example, a mobile device may include a smartphone, a tablet, a smartwatch, a laptop, and/or other mobile devices. The mobile device may use machine-readable optical code, as described herein, to connect to a wireless communication connection established by an image capture device (e.g., pair with a camera).

The display 14 may be configured to present one or more machine-readable optical codes and/or other information. The display 14 may be configured to present other visual information. In some implementations, the display 14 may include a display of a mobile device. For example, the display 14 may include a display of a smartphone, a tablet, a smartwatch, a laptop, and/or other mobile devices.

The electronic storage 12 may be configured to include electronic storage medium that electronically stores information. The electronic storage 12 may store software algorithms, information determined by the processor 11, information received remotely, and/or other information that enables the computing device 10 to function properly. For example, the electronic storage 12 may store information relating to computing device 10, setup information, credential information, machine-readable optical code, image capture device, wireless communication connection, and/or other information.

Referring to FIG. 1, the processor 11 may be configured to provide information processing capabilities in the computing device 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine readable instructions 100 to facilitate pairing the computing device 10 to an image capture device. The machine readable instructions 100 may include one or more computer program components. The machine readable instructions 100 may include one or more of a setup information component 102, an optical code component 104, a presentation component 106, a connection component 108, a communication component 110, and/or other computer program components.

The setup information component 102 may be configured to obtain setup information and/or other information. Obtaining setup information may include one or more of accessing, acquiring, analyzing, determining, examining, loading, locating, opening, receiving, retrieving, reviewing, storing, and/or otherwise obtaining the setup information. The setup information component 102 may obtain setup information from one or more storage locations. A storage location may include electronic storage 12, electronic storage of a device accessible via a network, and/or other locations.

The setup information may include credential information for the computing device 10 to connect to a wireless communication connection. A communication connection may refer to one or more connections/links between computing devices that enable a computing device connected to the communication connection to exchange (e.g., send, receive) information with one or more other computing devices connected to the communication connection. A communication connection may enable direct exchange of information (e.g., two computing devices directly exchanging information with each other) and/or indirect exchange of information (e.g., two computing devices indirectly exchanging information with each other through one or more intermediate computing devices). A wireless communication connection may refer to such connections/links that enable wireless exchange/transmission of information between computing devices. For example, a wireless communication connection may include one or more networks and/or other wireless communication connections. Networks may include private networks, public networks, and/or other networks.

Credential information may refer to information used to connect the computing device 10 to a wireless communication connection. Credential information may be static or dynamic (e.g., changes over time, location, circumstances). Credential information may identify/may be used to identify an identifier of a wireless communication connection, user(s) authorized to connect to the wireless communication connection, information used to verify that the user(s) are authorized to connect to the wireless communication connection, and/or other information.

For example, credential information may include one or more of a service set identifier, a user identifier, a user password, and/or other information. A service set identifier (SSID) may identify the wireless communication connection (e.g., network name). The user identifier may identify authorized users (e.g., a login name that may be used to login to a network). The user password may be used to verify that the user(s) are authorized to connect to the wireless communication connection (e.g., a password associated with the wireless communication connection, a password associated with a login name). The credential information may include other information which may be used to setup/establish a wireless communication connection.

In some implementations, the setup information may include parameter information that defines one or more parameters for setting up an image capture device. A parameter for setting up an image capture device may refer to information that may be used to set/change/control one or more characteristics of the image capture device, set/change/control one or more aspects of operation of the image capture device, and/or otherwise setup the image capture device. The parameter information may include/identify the parameter(s) for setting up the image capture device and/or may include information which may be used to identify the parameter(s) for setting up the image capture device.

One or more characteristics of the image capture device may refer to one or more features and/or qualities of the image capture device. One or more characteristics of the image capture device may be static or dynamic. For example, one or more characteristics of the image capture device may include image capture device identifier (e.g., device name), clock/timer of the image capture device, location of the image capture device, and/or other characteristics of the image capture device. In some implementations, one or more characteristics of the image capture device may include characteristic(s) that may be determined based on user input during a setup process (e.g., user onboarding process) and/or an update process.

For example, the setup information may include information which may be responsive to one or more inputs/selections/options a user may choose while (manually) setting up the image capture device through its onboarding process (e.g., a new user setup process, a device setup process) or relating to an update process (e.g., updating firmware/software of the image capture device). Other characteristics of the image capture device are contemplated.

One or more aspects of operation of the image capture device may include one or more aspects of operation of a processor of the image capture device, an image sensor of the image capture device, an optical element of the image capture device, and/or other aspects of operation of the image capture device. One or more aspects of operation of the image capture device may be defined for a time, over a period of time, at a location, or over a range of locations.

For example, one or more aspects of operation of the image capture device may include one or more of a capture mode, a capture resolution, a capture framerate, a capture field of view, a capture visual processing, a capture shutter speed, and/or other aspects of operation of the image capture device. A capture mode may refer to a pre-defined mode of operation of an image capture device. A capture mode may include manual modes and/or automatic modes. In some implementations, a capture mode may include an automatic capture mode. An image capture device operating in an automatic capture mode may capture visual content (e.g., images, videos) based on detection of particular visuals and/or audio. For example, an image capture device operating in an automatic capture mode may capture video content based on detection of a particular object, a particular action, a particular machine-readable optical code, a particular sound, and/or detection of other things/activity/events. A capture resolution may define the resolution at which visual content is captured. A capture frame rate may define the frame rate at which visual content is captured. A capture field of view may define the extent of an environment observable by an image capture device from a position/orientation. A capture visual processing may define visual manipulation performed by an image capture device during/after capture of visual content. A capture shutter speed may define the shutter speed at which visual content is captured.

For example, one or more aspects of operation of the image capture device may include single image capture, burst image capture, night lapse capture, image resolution, image framerate, camera field of view, zoon, image projection, image color balance, tonal curve, exposure compensation, color saturation, contrast, sharpening, softening, gamma, ISO limit, video stabilization, shutter speed, encoding parameters (e.g., codec type (H.264, HEVC), I-frame interval, macroblock size, deblocking filter, QP, capture timing (e.g., auto, interval, continuous, loop), and/or other aspects

In some implementations, one or more aspects of operation of the image capture device may include aspects of operation of one or more microphone/sound sensors of the image capture device. For example, one or more aspects of operation of the image capture device may include number of channels, sample rate, compression format (e.g., AAC, MP3), averaging/filter window duration, and/or other aspects.

In some implementations, one or more aspects of operation of the image capture device may include one or more conditions. For example, a particular operation included in the setup information may be performed by an image capture device based on occurrence of one or more events. One or more parameters for setting up an image capture device may include conditional requirements (e.g., If This Then That) that provides for one or more particular operations to be performed by the image capture device based on occurrence of certain conditions. For example, a parameter for setting up an image capture device may prompt the image capture device to use different capture resolutions and/or frame rates based on the type of visuals the image capture device is configured to capture (e.g., action mode, still mode). A parameter for setting up an image capture device may prompt the image capture device to capture images at particular locations (e.g., destination, way-points).

In some implementations, one or more aspects of operation of the image capture device may include aspects relating to other image capture devices. For example, the setup information may include may include information/parameter that allows an image capture device to synchronize capture of visual content with one or more other image capture devices. Other aspects of operation for the image capture device are contemplated.

In some implementations, obtaining the setup information may include effectuating presentation of options for the setup information on the display 14, and receiving a user's selection of at least one of the options as the setup information. The options for the setup information may be static (e.g., set options stored in the electronic storage 12, default options) and/or may be dynamic (changes over time, location, circumstances). The options for the setup information may enable a user to manually enter the setup information. For example, the options presented on the display 14 may include static options for the credential/parameter information, dynamic options for the credential/parameter information, and/or manual input options for the credential/parameter information. For example, the options presented on the display 14 may include one or more of different service set identifiers, different user identifiers, different user passwords, and/or other information which may be selected by the user for the credential information. The operations presented on the display 14 may enable a user to define one or more of a service set identifier, a user identifier, a user password, and/or other information which may be used for the credential information.

Obtaining the setup information via the computing device 10, rather than directly on an image capture device, may facilitate a user's setup of the image capture device. Obtaining the setup information via the computing device 10 may enable a user to define one or more characteristics of the image capture device, define one or more aspects of operation of the image capture device, and/or otherwise define setup of the image capture device without directly using the image capture device (e.g., the image capture device does not need to be turned on while the user is providing setup information, the user does not need to directly enter the setup information into the image capture device).

As image capture devices become smaller, physically interacting with buttons or touchscreens of the image capture devices to configure the image capture devices may become more difficult. Some image capture devices may not include display screen to display setup options. A user's interaction with the computing device 10 to provide setup information may be easier than the user's interaction with the image capture device because the image capture device may have limited options (e.g., limited display size, limited number of buttons) for the user to input/select the setup information.

In some implementations, the options may include one or more pre-stored options. For example, the options may include one or more of a service set identifier, a user identifier, a user password, and/or other information which may be stored in electronic storage 12 and/or other locations. In some implementations, the options may include one or more dynamically generated options. For example, the options may be generated based on user input, time, location, and/or circumstances. For example, one or more of a service set identifier, a user identifier, a user password, and/or other information used to setup the image capture device may change based on input, time, location, and/or circumstances. For example, a service set identifier may change based on information provided by a user, time/location of operation, and/or environment of operation (e.g., a default service set identifier may include “NETWORK-A.” Based on a network named “NETWORK-A” already existing with the environment of operation, the service set identifier may be changed to “NETWORK-B”).

The optical code component 106 may be configured to generate the machine-readable optical code based on the setup information and/or other information. A machine-readable optical code may include a visual representation of data. The visual representation of data may be readable by a computing device based on capture of an image/video including the machine-readable optical code. A machine-readable optical code may encode the data visually by varying the size and shape of patterns within the machine-readable optical code. The data may be encoded within a machine-readable optical code using one or more encoding modes.

In some implementations, a machine-readable optical code may include a one-dimensional machine-readable optical code (e.g., continuous or discrete barcodes), a two-dimensional machine-readable optical code (e.g., QR code), and/or a three-dimensional machine-readable optical code (e.g., holograms). In some implementations, a machine-readable optical code may include one or more varying components (e.g., a barcode/QR code/hologram that changes with time/location).

In some implementations, a two-dimensional machine-readable optical code may have dimensions of 480 pixels by 320 pixels. A machine-readable optical code may include corner elements (e.g., four or fewer corners for a QR code) that enable machine-readable optical code recognition while adjusting for scale, orientation, non-parallel reading plane, and data placed within the frame. Other dimensions and types of machine-readable optical codes are contemplated.

The machine-readable optical code may convey instructions configured to cause an image capture device to, in response to the image capture device capturing an image including the machine-readable optical code, establish the wireless communication connection. The image capture device may establish the wireless communication connection based on the machine-readable optical code such that the wireless communication connection uses at least some of the credential information. For example, the machine-readable optical code may have been generated based on credential information including one or more of a particular service set identifier, a particular user identifier, a particular user password, and/or other information. Based on the image capture device capturing an image including the machine-readable optical code, the image capture device may establish the wireless communication connection (e.g., network) with the particular service set identifier as its identifier. The wireless communication connection may be accessed by a computing device that provides the particular user identifier as the login name and the particular user password as the password associated with the login name.

The machine-readable optical code may convey instructions configured to cause the image capture device to, in response to the image capture device capturing the image including the machine-readable optical code, authenticate the computing device 10 to the wireless communication connection by virtue of the computing device 10 providing at least some of the credential information included in the setup information and/or other information. For example, based on the machine-readable optical code, the image capture device may have established a wireless communication connection (e.g., network) with a particular service set identifier as its identifier. The computing device 10 may attempt to connect to the wireless communication network with the particular service set identifier using a particular user identifier (e.g., login name) and a particular user password (e.g., password associated with the login name). The image capture device may authenticate the computing device 10 to the wireless communication connection based on the computing device providing one or more of the particular service set identifier, the particular user identifier, the particular service set identifier, and/or other information.

Such pairing of the computing device 10 with the image capture device may provide a reversal of roles in establishing/connecting to a wireless communication connection. Rather than a user of the computing device 10 having to determine what credential information are required to connect to a wireless communication connection established by the image capture device, credential information for assessing a wireless communication connection are provided by the computing device 10 to the image capture device via the machine-readable optical code, and the image capture device establishes (e.g., sets up, configures) the wireless communication connection based on the credential information provided by the computing device 10.

In some implementations, the machine-readable optical code may further convey instructions configured to cause the image capture device to, in response to the image capture device capturing the image including the machine-readable optical code, change one or more setting parameters of the image capture device based on the parameter(s) defined by the parameter information. For example, based on the machine-readable optical code, the image capture device may set/change/control one or more characteristics of the image capture device, set/change/control one or more aspects of operation of the image capture device, and/or otherwise change the setting of the image capture device. Such setup of the image capture device may facilitate a user's setup of the image capture device. Such setup of the image capture device may enable a user to indirectly setup the image capture device via the machine-readable optical code.

In some implementations, the machine-readable optical code may be configured such that multiple image capture devices may operate (e.g., establish wireless communication connection, authenticate the computing device 10 to the wireless communication connection, change image capture device setting) based on the instructions conveyed by the machine-readable optical code. In some implementations, the machine-readable optical code may be configured such that only certain image capture device(s) may operate based on the instructions conveyed by the machine-readable optical code. For example, the machine-readable optical code may convey instructions for particular image capture device(s) such that only the particular image capture device(s) (e.g., image capture devices with certain identifier/serial number, image capture devices of a certain make/model/version) may operate based on the instructions conveyed by the machine-readable optical code.

The presentation component 106 may be configured to effectuate presentation of the machine-readable optical code and/or other information on the display 14. The machine-readable optical code may be presented on the display at a time, over a period of time, at a location, or over a range of locations. The machine-readable optical code may be presented on the display 14 so that one or more image capture devices may capture one or more images including the machine-readable optical code. Providing information (e.g., setup information) to image capture devices via the machine-readable optical code may be more secure than other wireless means of providing information (e.g., over WiFi, Bluetooth communication) because the presentation of the machine-readable optical code is local and only those image capture devices with a view of the machine-readable optical code may obtain the information conveyed by the machine-readable optical code.

In some implementations, the presentation component 106 may effectuate presentation of the machine-readable optical code based on user input. For example, the machine-readable optical code may be presented on the display 14 based on user input (e.g., received via a button press, an interaction with a touchscreen interface, a wireless command received from another device, a voice command, a visual command).

In some implementations, the presentation component 106 may effectuate presentation of the machine-readable optical code based on proximity of the image capture device to the computing device 10. For example, the presentation component 106 may determine when the image capture device brought/located near the computing device 10 (e.g., based on signals received from the image capture device, based on sensor readings indicating positions of the image capture device and/or the computing device 10). Based on the distance/orientation of the image capture device to the computing device 10 meeting a threshold distance/orientation, the presentation component 106 may present the machine-readable optical code on the display 14.

In some implementations, the image capture device may be configured to continuously or periodically search for the machine-readable optical code within images captured by the image capture device. For example, the image capture device may be operating within a mode in which the image capture device continuously or periodically searches within captured images for machine-readable optical code(s) conveying instructions configured to cause the image capture device to establish the wireless communication connection, authenticate the computing device 10 to the wireless communication connection, and/or otherwise change characteristics/operations of the image capture device. The image capture device may operate in such a mode as a default or based on user input (e.g., user input indicating that the image capture device should operate in a machine-readable optical code search mode)

In some implementations, the image capture device may be configured to search for the machine-readable optical code within images captured by the image capture device based on user input and/or other information. For example, the user input may prompt the impute capture device to search one or more captured images for machine-readable optical code(s) conveying instructions configured to cause the image capture device to establish the wireless communication connection, authenticate the computing device 10 to the wireless communication connection, and/or otherwise change characteristics/operations of the image capture device. The user input may be received before the image(s) are captured, during the capture of image(s), or after the image(s) are captured by the image capture device.

In some implementations, one or more image capture devices may decode the machine-readable optical code using a resolution different than the resolution of the image that captured the machine-readable optical code. For example, an image capture device may be configured to store visual content at a high resolution (e.g., 4K). Decoding machine-readable optical codes using the high resolution may require expenditure of more resources (e.g., computing power/time, memory storage) than necessary. The image capture device(s) may be configured to utilize lower resolution version of the visual content for decoding the machine-readable optical codes. In some implementations, an image (e.g., a lower resolution image) for decoding the machine-readable optical codes may be transformed into a two-tone representation (e.g., black and white). The two-tone image may be analyzed in order to determine a spatial pattern of the machine-readable optical code and determine the instructions conveyed by the machine-readable optical code.

The connection component 108 may be configured to connect to the wireless communication connection by wirelessly providing at least some of the credential information and/or other information to the image capture device. For example, the connection component 108 may provide one or more of a particular service set identifier, a particular user identifier, a particular user password, and/or other information to the image capture device to connect to the wireless communication connection. For example, the connection component 108 may use the particular service set identifier to locate the wireless communication connection and provide the particular user identifier and/or the particular user password to the image capture device. The particular service set identifier, a particular user identifier, a particular user password, and/or other information provided to the image capture device may include the particular service set identifier, the particular user identifier, the particular user password, and/or other information included in the credential information that was used to generate the machine-readable optical code.

In some implementations, the connection component 108 may, prior to connecting to the wireless communication connection, detect the wireless communication connection. Detecting the wireless communication connection prior to connecting to the wireless communication connection may enable the computing device 10 to save resources. For example, after an machine-readable optical code (conveying instructions configured to cause an image capture device capturing an image including the machine-readable optical code to establish a wireless communication connection with a service set identifier “NETWORK-A”) has been presented on the display 14, the connection component 108 may search for the wireless communication connection with the service set identifier “NETWORK-A.” Upon detecting the wireless communication connection with the service set identifier “NETWORK-A,” the connection component 108 may providing at least some of the credential information and/or other information to the image capture device to connect to the wireless communication connection.

The communication component 110 may be configured to communicate with the image capture device via the wireless communication connection. Communication with the image capture device may include information provided to the image capture device by the computing device 10, information transmitted to the image capture device by the computing device 10, information provided by the image capture device to the computing device 10, and/or information received from the image capture device by the computing device 10. The communication component 110 may communicate with the image capture device via the wireless communication connection to send information to the image capture device (e.g., send information relating to image capture device characteristics and/or operations). For example, the communication component 110 may send, via the wireless communication connection, information relating to how the image capture device should operate to capture visual content.

The communication component 110 may communicate with the image capture device via the wireless communication connection to receive information from the image capture device (e.g., receive information relating to image capture device characteristics and/or operations, receive information relating to visual content captured by the image capture device). For example, the communication component 110 may receive, via the wireless communication connection, images/videos (and/or thumbnails of images/videos) captured by the image capture device. Communication of other information between the communication component 110 and the image capture device are contemplated.

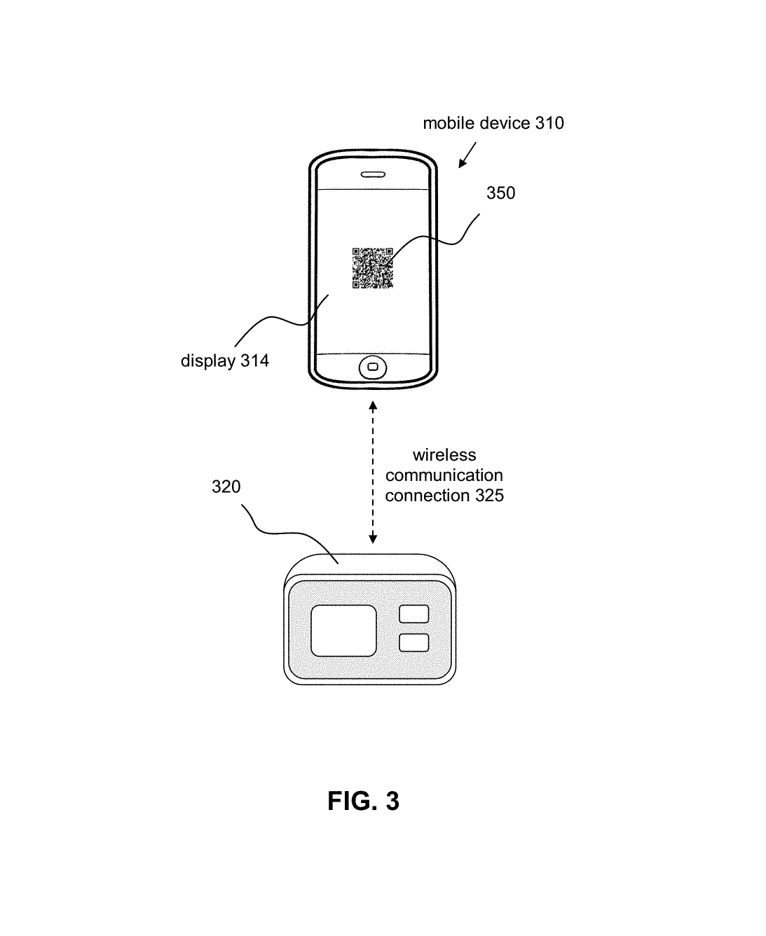

FIG. 3 illustrates an example display of a machine-readable optical code 350 by a mobile device 310 for pairing with an image capture device 320. The mobile device 310 may obtain setup information, including credential information. The mobile device 310 may generate the machine-readable optical code 350 based on the setup information. The mobile device 310 may present the machine-readable optical code 350 on its display 314. The machine-readable optical code 350 may convey instructions configured to cause the image capture device 320 to, in response to the image capture device 320 capturing an image including the machine-readable optical code 350, establish a wireless communication connection 325 and authenticate the mobile device 310 to the wireless communication connection 325 by virtue of the mobile device 310 providing at least some of the credential information included in the setup information. The mobile device 320 may capture one or more images including the machine-readable optical code 350 and establish the wireless communication connection 325. The mobile device 310 may connect to the wireless communication connection 325 by wirelessly providing at least some of the credential information to the image capture device 320.

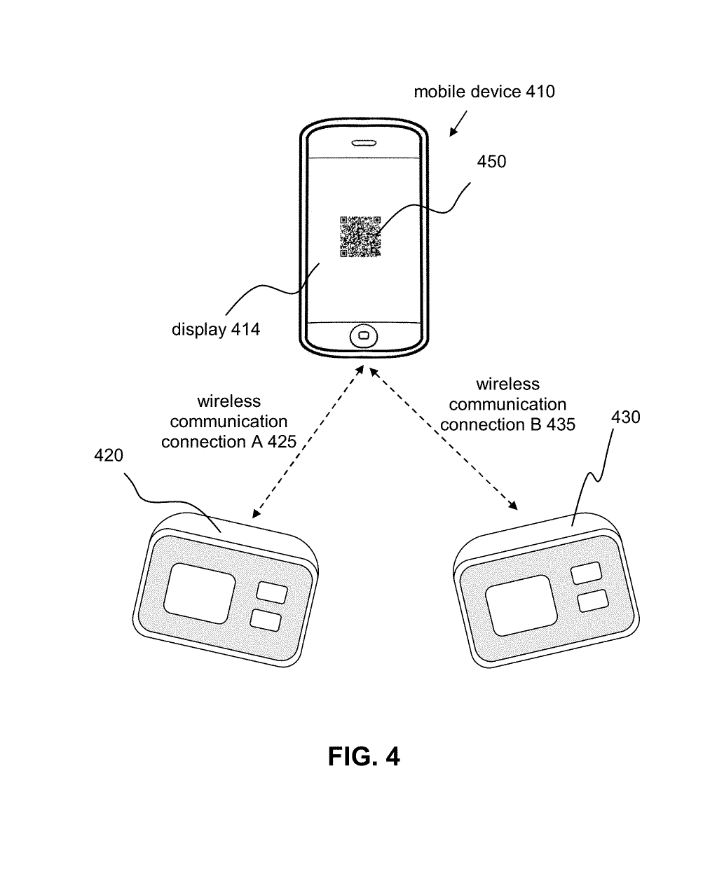

FIG. 4 illustrates an example display of a machine-readable optical code 450 for pairing with multiple image capture devices 420, 430. The mobile device 410 may obtain setup information, including credential information. The mobile device 410 may generate the machine-readable optical code 450 based on the setup information. The mobile device 410 may present the machine-readable optical code 450 on its display 414. The machine-readable optical code 450 may convey instructions configured to cause the image capture devices 420, 430 to, in response to the image capture devices 420, 430 capturing an image including the machine-readable optical code 450, establish wireless communication connections 425, 435 and authenticate the mobile device 410 to the wireless communication connections 425, 435 by virtue of the mobile device 410 providing at least some of the credential information included in the setup information.

For example, at a first time, the mobile device 420 may capture one or more images including the machine-readable optical code 450 and establish the wireless communication connection A 425. The mobile device 410 may connect to the wireless communication connection A 425 by wirelessly providing at least some of the credential information to the image capture device 420. At a second time subsequent to the first time, the mobile device 430 may capture one or more images including the machine-readable optical code 450 and establish the wireless communication connection B 435. The mobile device 410 may connect to the wireless communication connection B 435 by wirelessly providing at least some of the credential information to the image capture device 430. Thus, the same machine-readable optical code 450 may be used by the mobile device 410 to pair with the image capture devices 420, 430 at different times.

In some implementations, the setup information (e.g., credential information, parameter information) used to generate the machine-readable optical code 450 may be changed. For example, the wireless communication connection A 425 may have a service set identifier of “NETWORK-A” based on the credential information used by the mobile device 410 to generate the machine-readable optical code 450. Use of the service set identifier of “NETWORK-A” for the wireless communication connection B 435 may cause problems with pairing between the mobile device 410 and the image capture devices 420, 430. The mobile device 410 may detect that the wireless communication connection A 425 already exists with the service set identifier of “NETWORK-A.” The mobile device 410 may change the credential information to include service set identifier of “NETWORK-B” and changed the machine-readable optical code 450 (e.g., generate a new machine-readable optical code) based on the changed setup/credential information. Based on the machine-readable optical code, the image capture device 430 may establish the wireless communication connection B 435 with the service set identifier of “NETWORK-B.” Thus, the machine-readable optical code 450 may be changed to enable the mobile device 410 to pair with different image capture device 420, 430 using different setup information.

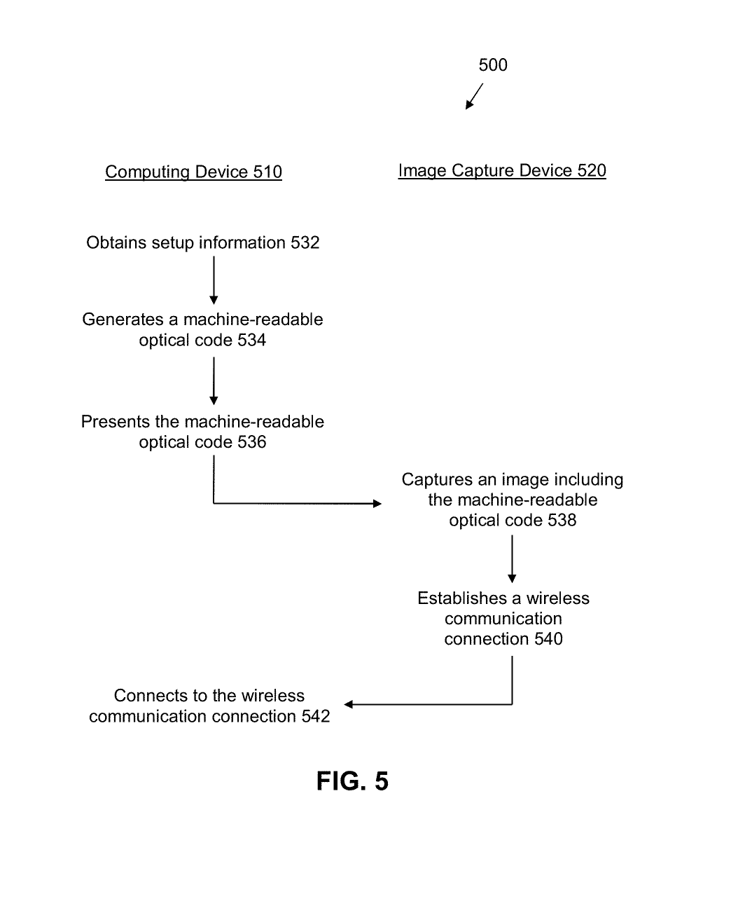

FIG. 5 illustrates an example process 500 for pairing with an image capture device. A computing device 510 may obtain setup information 532 including credential information. The computing device 510 may generate a machine-readable optical code 534 based on the setup information and/or other information. The computing device 510 may present the machine-readable optical code 536 on a display. An image capture device 520 may capture an image including the machine-readable optical code 538. The image capture device 520 may establish a wireless communication connection 540 based on the machine-readable optical code and/or other information. The computing device 510 may connect to the wireless communication connection 542 by wirelessly providing at least some of the credential information.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 11 and electronic storage 12 are shown to be connected to interface 13 in FIG. 1, any communication medium may be used to facilitate interaction between any components of computing device 10. One or more components of computing device 10 may communicate with each other through hard-wired communication, wireless communication, or both. For example, one or more components of computing device 10 may communicate with each other through a network. For example, processor 11 may wirelessly communicate with electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which the processor 11 comprises multiple processing units, one or more of computer program components may be located remotely from the other computer program components.

While the computer program components are described herein as being implemented via processor 11 through machine readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components 102 and/or 104 may be eliminated, and some or all of its functionality may be provided by other computer program components. As another example, the processor 11 may be configured to execute one or more additional computer program components that may perform some or all of the functionality attributed to one or more of computer program components 102 and/or 104 described herein.

The electronic storage media of the electronic storage 12 may be provided integrally (i.e., substantially non-removable) with one or more components of the computing device 10 and/or removable storage that is connectable to one or more components of the computing device 10 via, for example, a port (e.g., a USB port, a Firewire port, etc.) or a drive (e.g., a disk drive, etc.). The electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 12 may be a separate component within the computing device 10, or the electronic storage 12 may be provided integrally with one or more other components of the computing device 10 (e.g., the processor 11). Although the electronic storage 12 is shown in FIG. 1 as a single entity, this is for illustrative purposes only. In some implementations, the electronic storage 12 may comprise a plurality of storage units. These storage units may be physically located within the same device, or the electronic storage 12 may represent storage functionality of a plurality of devices operating in coordination.

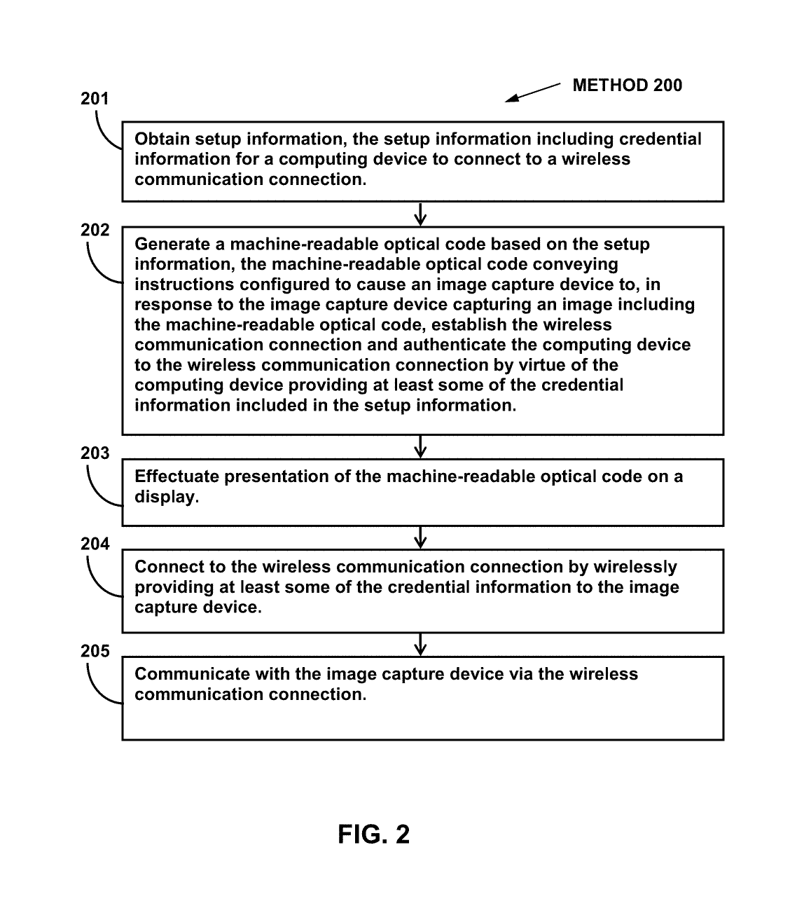

FIG. 2 illustrates method 200 for pairing with an image capture device. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, setup information may be obtained. The setup information may include credential information for a computing device to connect to a wireless communication connection. In some implementation, operation 201 may be performed by a processor component the same as or similar to the setup information component 102 (Shown in FIG. 1 and described herein).

At operation 202, a machine-readable optical code may be generated based on the setup information. The machine-readable optical code may convey instructions configured to cause the image capture device to, in response to the image capture device capturing an image including the machine-readable optical code, establish the wireless communication connection and authenticate the computing device to the wireless communication connection by virtue of the computing device providing at least some of the credential information included in the setup information. In some implementations, operation 202 may be performed by a processor component the same as or similar to the optical code component 104 (Shown in FIG. 1 and described herein).

At operation 203, presentation of the machine-readable optical code on a display may be effectuated. In some implementations, operation 203 may be performed by a processor component the same as or similar to the presentation component 106 (Shown in FIG. 1 and described herein).

At operation 204, connection to the wireless communication connect may be made by wirelessly providing at least some of the credential information to the image capture device. In some implementations, operation 204 may be performed by a processor component the same as or similar to the connection component 108 (Shown in FIG. 1 and described herein).

At operation 205, communication with the image capture device may be effectuated via the wireless communication connection. In some implementations, operation 205 may be performed by a processor component the same as or similar to the communication component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A computing device that pairs with an image capture device, the computing device comprising:
a display configured to present a machine-readable optical code; and
one or more physical processors coupled to the display, the one or more physical processors configured by machine-readable instructions to:
obtain setup information, the setup information including credential information for the image capture device to set up a wireless network, the credential information including a service set identifier and a user password;
generate the machine-readable optical code based on the setup information, the machine-readable optical code conveying first instructions configured to cause the image capture device to, in response to the image capture device capturing an image including the machine-readable optical code, set up the wireless network, wherein the wireless network is identified by the service set identifier and authorization to connect to the wireless network is verified by the user password;
effectuate presentation of the machine-readable optical code on the display;
connect to the wireless network set up by the image capture device by wirelessly providing at least some of the credential information to the image capture device; and
communicate with the image capture device via the wireless network.

2. The computing device of claim 1, wherein the credential information further includes user identifier associated with the user password.

3. The computing device of claim 1, wherein the one or more physical processors are, to obtain the setup information, further configured by the machine-readable instructions to receive user input defining the setup information.

4. The computing device of claim 1, wherein the one or more physical processors are, to obtain the setup information, further configured by the machine-readable instructions to:
effectuate presentation of options for the setup information on the display; and
receive a user's selection of at least one of the options as the setup information.

5. The computing device of claim 4, wherein the options include a pre-stored option.

6. The computing device of claim 4, wherein the options include a dynamically-generated option.

7. The computing device of claim 1, wherein the setup information further includes parameter information that defines a parameter for setting up the image capture device, and the machine-readable optical code further conveys second instructions configured to cause the image capture device to, in response to the image capture device capturing the image including the machine-readable optical code, change a setting parameter of the image capture device based on the parameter defined by the parameter information.

8. The computing device of claim 1, wherein the image capture device is configured to continuously or periodically search for the machine-readable optical code within images captured by the image capture device. (Original) The computing device of claim 1, wherein the image capture device is configured to search for the machine-readable optical code within images captured by the image capture device based on user input.

10. A method for pairing with an image capture device, the method performed by a computing system including one or more physical processors, the method comprising:
obtaining, by the computing device, setup information, the setup information including credential information for the image capture device to set up a wireless network, the credential information including a service set identifier and a user password;
generating, by the computing device, the machine-readable optical code based on the setup information, the machine-readable optical code conveying first instructions configured to cause the image capture device to, in response to the image capture device capturing an image including the machine-readable optical code, set up the wireless network, wherein the wireless network is identified by the service set identifier and authorization to connect to the wireless network is verified by the user password;
effectuating, by the computing device, presentation of the machine-readable optical code on a display;
connecting, by the computing device, to the wireless network set up by the image capture device by wirelessly providing at least some of the credential information to the image capture device; and
communicating, by the computing device, with the image capture device via the wireless network.

11. The method of claim 10, wherein the credential information further includes a user identifier associated with the user password.

12. The method of claim 10, wherein obtaining the setup information includes receiving user input defining the setup information.

13. The method of claim 10, wherein obtaining the setup information includes:
effectuating presentation of options for the setup information on the display; and
receiving a user's selection of at least one of the options as the setup information.

14. The method of claim 13, wherein the options include a pre-stored option.

15. The method of claim 13, wherein the options include a dynamically-generated option.

16. The method of claim 10, wherein the setup information further includes parameter information that defines a parameter for setting up the image capture device, and the machine-readable optical code further conveys second instructions configured to cause the image capture device to, in response to the image capture device capturing the image including the machine-readable optical code, change a setting parameter of the image capture device based on the parameter defined by the parameter information.

17. The method of claim 10, wherein the image capture device is configured to continuously or periodically search for the machine-readable optical code within images captured by the image capture device. (Original) The method of claim 10, wherein the image capture device is configured to search for the machine-readable optical code within images captured by the image capture device based on user input.

19. (canceled)

20. (canceled)

21. The computing device of claim 7, wherein the setting parameter of the image capture device includes an image capture device identifier of the image capture device, a clock or a timer of the image capture device, or a location of the image capture device.

22. The computing device of claim 7, wherein the setting parameter of the image capture device includes an aspect of operation of the image capture device to capture images, wherein the aspect of operation of the image capture device to capture images includes a capture mode, a capture resolution, a capture framerate, a capture field of view, a capture visual processing, or a capture shutter speed.
